(19) United States
(12) Patent Application Publication
(10) Pub. No.: US 2013/0068586 A1
(43) Pub. Date: Mar. 21, 2013

(54) COIN DISCRIMINATORS

(71) Applicants: Manfred Jonsson, Staffanstorp (SE); Geoffrey Howells, Shropshire (GB); Simon Scott Brown, Shropshire (GB)

(72) Inventors: Manfred Jonsson, Staffanstorp (SE); Geoffrey Howells, Shropshire (GB); Simon Scott Brown, Shropshire (GB)

(21) Appl. No.: 13/678,767

(22) Filed: Nov. 16, 2012

Related U.S. Application Data
(63) Continuation of application No. PCT/GB2011/050940, filed on May 17, 2011.

(30) Foreign Application Priority Data
May 17, 2010 (GB) 1008177.6
May 17, 2011 (GB) PCT/GB2011/050940

(51) Int. Cl. G07D 5/08

(52) U.S. Cl. CPC G07D 5/08
USPC 194/317

(57) ABSTRACT

Disclosed are various apparatus and methods for discriminating between fake and reject coins. The term ‘coin’ includes any type of monetary token or token that is associated with a value. Various different apparatus and methods are disclosed. These include a method and apparatus of applying multiple input currents of different frequencies to a coin and monitoring the apparent change in impedance of a coil or coils resulting from eddy currents induced in the layers of the coin from the multiple input currents. Other methods and apparatus relate to applying electromagnetic radiation to the coin and measuring various resulting characteristics including the amount of light fluoresced or reflected from the coin, or the absorption characteristic of the coin. Other methods and apparatus relate to measuring vibration of a coin. Other methods and apparatus relate to identifying genuine and bogus coins via particular identifying characteristics of the coins including magnetic codes/serial numbers.

### CROSS-REFERENCE TO RELATED APPLICATIONS

This application is a continuation application of prior PCT application No. PCT/GB2011/050940, filed May 17, 2011, and designating the United States, entitled “Coin Discriminators” which PCT application claims the benefit of British Patent Application No. 1008177.6, filed on May 17, 2010.

### INCORPORATION BY REFERENCE

The entire disclosures of PCT Application No. PCT/GB2011/050940, filed May 17, 2011 and British Patent Application No. 1008177.6, filed on May 17, 2010, are incorporated herein by reference as if set forth in their entireties.

The present invention relates to coin discriminators and to methods of discriminating between genuine coins and reject coins.

The term ‘coin’ is used herein to include any type of monetary token or token having value, metal currency, plastic or non-metallic token, a counterfeit coin, a component of a composite coin, or a washer for example. The coin may be disc shaped or generally disc shaped, or may be any other desired shape of generally planar form, such as square, oblong or oval for example.

Coin discriminators are used for measuring different characteristics of a coin in order to determine its type, eg its denomination, currency or authenticity. Various dimensional, electric and magnetic characteristics are measured for this purpose, such as the diameter and thickness of the coin, its electrical conductivity, its magnetic permeability, and its surface and/or edge pattern, eg its edge knurling. Coin discriminators are commonly used in coin handling machines, such as coin counting machines, coin sorting machines, vending machines, gaming machines, etc. Examples of previously known coin handling machines are for instance disclosed in WO 97/07485 and WO 87/07742.

There is an evolving problem in the art of how to quickly, reliably and robustly discriminate between genuine and reject coins. Increasingly there is a need to be able to do this in connection with a variety of different coins of different denominations and different currencies.

The present invention stems from some work involved in attempting to alleviate these problems.

The term ‘reject’ is used herein to include any fake, bogus or unwanted coin (such as a foreign coin for example), and thus includes, but is not limited to, any counterfeit coin, slug, any damaged coin, or coin with a defect.

Multi-frequency Surface Conductivity

According to a first aspect of the invention there is provided a coin discriminator for discriminating between genuine coins of the type comprising a predetermined number of layers of different metals, and bogus coins, the discriminator comprising a coin inlet for receiving a coin under test and a coil or coils adjacent to a coin path from the coin inlet through the discriminator, the coil or coils being operative to generate a plurality of input currents of different frequencies to induce eddy currents in the layers of the coin, the discriminator comprising an electronic processor operative to monitor the apparent change of impedance of the coil or coils resulting from the eddy currents induced in the layers of the coin to produce a plurality of output signals indicative of changes of said impedance, the electronic processor being further operative to compare the plurality of output signals against stored reference data for a genuine coin, to determine whether or not the coin is a genuine coin.

According to a further aspect of the invention there is provided a method of distinguishing between genuine coins of the type comprising a predetermined number of layers of different metals, and bogus coins using a coin discriminator comprising a coin inlet for receiving a coin under test and a coil or coils adjacent to a coin path from the coin inlet through the discriminator, the method comprising steps of controlling the coil or coils to generate a plurality of input currents of different frequencies to induce eddy currents in the layers of the coin, measuring the apparent change of impedance of the coil or coils resulting from the eddy currents induced in the layers of the coin to produce a plurality of output signals indicative of changes of said impedance, comparing the plurality of output signals against stored reference data for a genuine coin using an electronic processor, to determine whether or not the coin is a genuine coin.

Electromagnetic Fluorescence/Reflectance

According to an aspect of the invention there is provided a coin discriminator for detecting the metal content of a coin, the discriminator comprising a coin inlet for receiving coins under test, at least one electromagnetic radiation emitter adjacent to a coin path from the coin inlet through the discriminator, and at least one electromagnetic radiation detector, the discriminator being operative such that in use, when a coin passes along the coin path, the emitter emits incident radiation onto the coin, the emitted radiation being sufficient that the coin emits radiation, or reflects radiation, onto the detector which generates an output signal in dependence upon the detected radiation, an electronic processor being provided to compare the output signal to stored reference data to determine the material of the coin that corresponds to the radiation detected.

It is envisaged that more than one detector be provided. Thus a detector can be provided adjacent to both sides of the coin so as to detect radiation emitted from both sides of the coin.

The emitted electromagnetic radiation may be x-rays for example.

The emitted electromagnetic radiation may be fluorescent radiation for example.

The frequency of the emitted electromagnetic radiation may be arranged to generate fluorescence, when incident on a coin.

The frequency of the emitted electromagnetic radiation may be arranged to generate reflected radiation, when incident on the coin.

By ‘fluorescence’ we mean the emission of electromagnetic radiation by a substance that has absorbed radiation of a different wavelength.

By ‘reflectance’ we mean the radiation reflected from the coin surface in response to radiation incident on the surface with the same wavelength or wavelength range.

According to another aspect of the invention there is provided a method of detecting the alloy content of a coin using a discriminator comprising a coin inlet for receiving coins under test, at least one electromagnetic radiation emitter adjacent to a coin path from the coin inlet through the discriminator, and at least one electromagnetic radiation detector, the method comprising steps of, when a coin passes along the coin path, controlling the emitter to emit incident electromagnetic radiation onto the coin, the emitted electromagnetic radiation being sufficient that the coin emits radiation, or reflects radiation, onto the detector, generating an output signal from the detector in dependence upon the detected emitted or reflected radiation, using an electronic processor to compare the output signal to stored reference data to determine the material of the coin that corresponds to the emitted or reflected radiation detected.

Electromagnetic Radiation Absorption

According to another aspect of the invention there is provided a coin discriminator for detecting the metal content of a coin, the discriminator comprising a coin inlet for receiving coins under test, at least one electromagnetic radiation emitter adjacent to a coin path from the coin inlet through the discriminator, and at least one electromagnetic radiation detector, the discriminator being operative such that in use, when a coin passes along the coin path, the emitter is operative to emit incident electromagnetic radiation of multiple wavelengths onto the coin, some of the electromagnetic radiation being absorbed by the coin, whilst some of the incident electromagnetic radiation pass through the coin and are detected by the detector which generates an output signal in dependence upon the electromagnetic radiation detected, the output signal being representative of at least one absorption characteristic of the material of the coin, the discriminator further comprising an electronic processor operative to compare change(s) in the at least one absorption characteristic of the coin as the wavelength of the electromagnetic radiation changes to stored reference data to determine the material of the coin that corresponds to the change(s) in the at least one absorption characteristic of the coin.

It is envisaged that the electromagnetic radiation be x-ray radiation.

According to a further aspect of the invention there is provided a method of detecting the metal content of a coin using a discriminator comprising a coin inlet for receiving coins under test, at least one electromagnetic radiation emitter adjacent to a coin path from the coin inlet through the discriminator, and at least one electromagnetic radiation detector, the method comprising steps of controlling the emitter when a coin passes along the coin path to emit incident electromagnetic radiation of multiple wavelengths onto the coin, some of the electromagnetic radiation being absorbed by the coin, detecting the incident electromagnetic radiation that pass through the coin using the detector, generating an output signal in dependence upon the electromagnetic radiation detected, the output signal being representative of at least one absorption characteristic of the material of the coin, using an electronic processor to compare change(s) in the at least one absorption characteristic as the wavelength of the electromagnetic radiation changes to stored reference data to determine the material of the coin that corresponds to the change(s) in the at least one absorption characteristic of the coin.

Colour in Visible and Non-Visible Wavelengths

According to another aspect of the invention there is provided a coin discriminator for discriminating between genuine and reject coins, the discriminator comprising a coin inlet for receiving a coin under test, at least one light emitter adjacent to a coin path from the coin inlet through the discriminator, and at least one light detector, the discriminator being operative such that in use, when a coin passes along the coin path, the light emitter emits light-rays of varying wavelengths onto the coin, the detector detecting said light-rays which reflect off the coin and generating an output signal in dependence upon the magnitude of the reflected light-rays detected, the output signal thus being representative of the reflectance of material of the coin, the discriminator further comprising an electronic processor operative to compare the reflectance of the coin to stored reference data to generate a signal indicative of whether or not the coin is genuine.

Preferably the electronic processor processes the output signals by scaling the measured reflectance of the coin against pre-determined wavelengths to create processed signals indicative of the relative reflectance of the coin, this relative reflectance being compared against a stored set of reference values of relative reflectance of a genuine coin to determine if the coin under test is genuine.

Thus preferably the reflectance of the coin is measured against a range of wavelengths so that the processed signals are indicative of the reflectance of the coin as distributed over the range of wavelengths.

By normalising the measured reflectance at one wavelength and measuring it at another wavelength, the measured reflectance is compensated to cope with dulled coins where the absolute value of reflectance is determined by the amount of tarnish.

According to a further aspect of the invention there is provided a method of detecting the metal content of a coin using a coin discriminator comprising a coin inlet for receiving a coin under test, at least one light emitter adjacent to a coin path from the coin inlet through the discriminator, and at least one light detector, the method comprising steps of controlling the light emitter to emit light-rays of varying wavelengths onto the coin, using the detector to detect light-rays which reflect off the coin, generating output signals dependent upon the magnitude and wavelength of the reflected light-rays detected by the detector, the output signal thus being representative of the reflectance of material of the coin, comparing the reflectance of the coin to stored reference data using an electronic processor to generate a signal indicative of whether or not the coin is genuine.

Sound of a Coin Ringing

According to another aspect of the invention there is provided a coin discriminator for discriminating between genuine and reject coins, the discriminator comprising a coin inlet for receiving a coin under test, a coin impact surface against which the coin impacts after having entered the coin inlet, and an vibration sensor adjacent to the coin impact surface operative to generate an output signal indicative of the frequency components of the vibration generated in use from the coin impacting the impact surface, the output signal therefore being representative of the characteristics of the coin, the discriminator comprising an electronic processor operative to compare the frequency components of the generated vibration to stored reference data to generate a signal indicative of whether or not the coin is genuine.

The characteristics of the coin may comprise hardness and/or mass for example.

The vibration sensor may comprise an ultrasonic microphone or an accelerometer. The vibration may be sensed through the air or a solid material. The vibration sensor could comprise a piezoelectric sensor operative to convert the force applied to the sensor into an electric output current that is proportional to the applied force.

The vibration sensor may be arranged to be directly impacted by the coin, or may be provided with an intermediate impact plate that is impacted by the coin.

The vibration sensor may be operative to discriminate between relatively soft coins and relatively hard coins.

According to a further aspect of the invention there is provided a method of detecting the characteristics of a coin using a coin discriminator comprising a coin inlet for receiving a coin under test, a coin impact surface onto which the coin impacts after having entered the coin inlet, and an ultrasonic microphone adjacent to the coin impact surface, comprising the steps of allowing the coin to impact the coin impact surface operative, using the microphone to generate an output signal indicative of the frequency components of the sound generated in use from the coin impacting the impact surface, the output signal therefore being representative of characteristics of the coin, comparing the frequency components of the generated sound to stored reference data using an electronic processor to generate a signal indicative of whether or not the coin is genuine.

Eddy Current Harmonics

According to a further aspect of the invention there is provided a coin discriminator for discriminating between genuine and reject coins of the type comprising at least two materials, the discriminator comprising a coin inlet for receiving a coin under test, and an induction coil adjacent to a coin path from the coin inlet through the discriminator, the induction coil being operative to apply an input current at the coin at a first frequency to induce an eddy current across a boundary between two of the materials of the coin, monitoring means being provided to generate an output signal indicative of the output of the coil as generated by the eddy current, an electronic processor being provided to process the output signal to determine if the output of the coil is at a harmonic frequency to the coil input current indicative of a change in resistance at the boundary between the materials of the coin.

The or each material may be a metal material.

The output of the coil may be at a second or third harmonic frequency to the coil input current.

The coil may be operative to induce an eddy current adjacent to multiple boundaries of the coin, if the coin comprises more than two materials. Additional coils may be provided for this purpose.

It is envisaged that the discriminator is operative to test coins of the type comprising an outer ring of one metal and an inner disc of another metal, and/or coins of the type comprising layers of different metals. The boundary may be in the form of an oxide layer arranged to produce imperfect electrical contact between the two parts of the coin. It is further envisaged that the boundary between the two metals may alternatively comprise a semi-conductor material, the presence of which alters the response in a way that can be detected. This creates a diode effect whereby current can flow more easily across the boundary in one direction than the other.

According to a further aspect of the invention there is provided a method of detecting a characteristic of a coin of the type comprising at least two materials, using a coin discriminator comprising a coin inlet for receiving a coin under test, and an induction coil adjacent to a coin path from the coin inlet through the discriminator, the method comprising steps of controlling the induction coil to apply an input current at the coin at a first frequency to induce an eddy current across a boundary between the two materials of the coin, using an electronic processor to generate an output signal indicative of the output of the coil as generated by the eddy current, processing the output signal using the electronic processor to determine if the output of the coil is at a harmonic frequency to the coil input current indicative of a non-linear change in resistance at the boundary between the two materials of the coin.

Resonant Absorption

According to another aspect of the invention there is provided a coin discriminator for discriminating between genuine and reject coins of the type comprising at least two materials, the discriminator comprising a coin inlet for receiving a coin under test, and an induction coil adjacent to a coin path from the coin inlet through the discriminator, the induction coil being operative to apply an input current at the coin at a boundary between two of the materials of the coin, the frequency being selected such that the boundary between the two materials of a genuine coin absorbs the applied input current, monitoring means being provided to generate an output signal indicative of the absorption of the applied current, an electronic processor being provided to process the output signal to confirm or otherwise the presence of an absorption layer in the coin indicative of a genuine coin.

Core Crinkles/Magnetic Code

According to another aspect of the invention there is provided a method of manufacturing a coin comprising an inner core and an outer plated layer, the core being provided with identification means underneath the plated layer arranged to alter a characteristic of the core beneath the plated layer as compared to that characteristic of the remainder of the core, comprising steps of forming the coin core of a first material, plating the coin core with a different material from the coin core material, and applying identification means to the coin core.

The step of applying the identification means to the coin core may comprise a step of stamping a pattern onto the coin core, subsequent to plating the core with a different material from the coin core material.

The step of applying the identification means to the coin core may comprise a step of altering a physical characteristic of the coin such as the thickness of at least part of the core.

The step of applying the identification means to the coin core may comprise a step of forming a raised protrusion that projects above a surface of the core, or may forming a recess below the surface of the core.

The step of applying the identification means to the coin core may comprise a step of altering an electro-magnetic characteristic of the coin such as an alteration in the magnetism of at least part of the core.

The step of applying the identification means to the coin core may comprise a step of arranging the identification means as a circle concentric with the coin periphery. The pattern may comprise multiple elements such as multiple circles for example.

The physical or electromagnetic identification means may be formed from the same material as the core or from a different material. For example an electromagnetic identification means may be formed from one metal that has different electromagnetic properties from the remainder of the coin.

According to a further aspect of the invention there is provided a method of discriminating a coin comprising steps of passing the coin past an identification sensor and using the output from the sensor to detect the identification means of the coin and thus identify the coin.

The identification sensor may comprise a coil, the method comprising steps of controlling the coil to apply a current across a chord of the coin to induce eddy currents across the chord of the coin, measuring the variance in the induced eddy currents across the chord of the coin and using the variance to determine the variance in surface conductivity and therefore thickness of the coin across the chord.

The identification sensor may comprise a magnetic (permeability) sensor, the method comprising steps of using the magnetic detector to measure the variance of the electro-magnetic properties across the coin.

According to another aspect of the invention, there is provided a method of discriminating a coin of the type at least partially formed from an electro-magnetically active region, comprising steps of using a data recorder to attempt to store data on the electro-magnetically active region of the coin, and subsequently using a data reader to attempt to read any data transferred onto the electro-magnetically active region of the coin.

If any data is read by the data reader, this is used to confirm the presence and/or thickness of an electro-magnetically active region of a coin.

Serial Number

According to another aspect of the invention there is provided a coin discriminator for discriminating between genuine and reject coins, comprising a coin inlet and a coin identification sensor adjacent to a coin path through the discriminator from the coin inlet and operative to detect identification means on the coin and to generate an output signal indicative of the identification means of the coin, the discriminator further comprising an electronic processor operative to process the output signal to determine if the coin is genuine.

The sensor may comprise an image sensor.

The sensor may comprise a laser reader.

The sensor may comprise an RFID scanner.

The sensor may comprise a barcode scanner.

Other aspects of the present invention may include any combination of the features or limitations referred to herein.

The present invention may be carried into practice in various ways, but embodiments will now be described by way of example only with reference to the accompanying drawings in which:

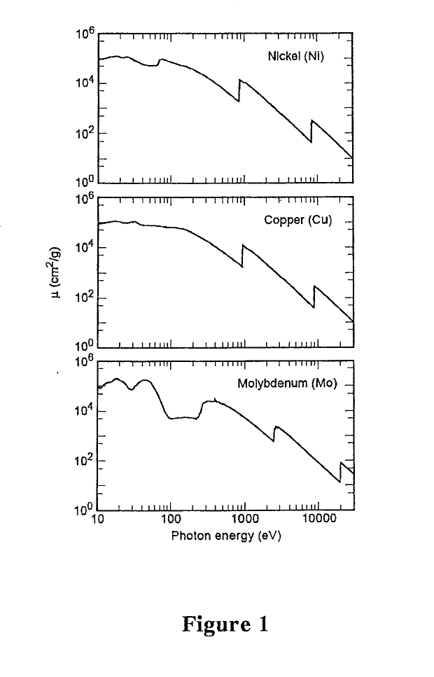

FIG. 1 is a graph showing how the absorption coefficient of various metals varies with the wavelength of x-ray applied to the metal;

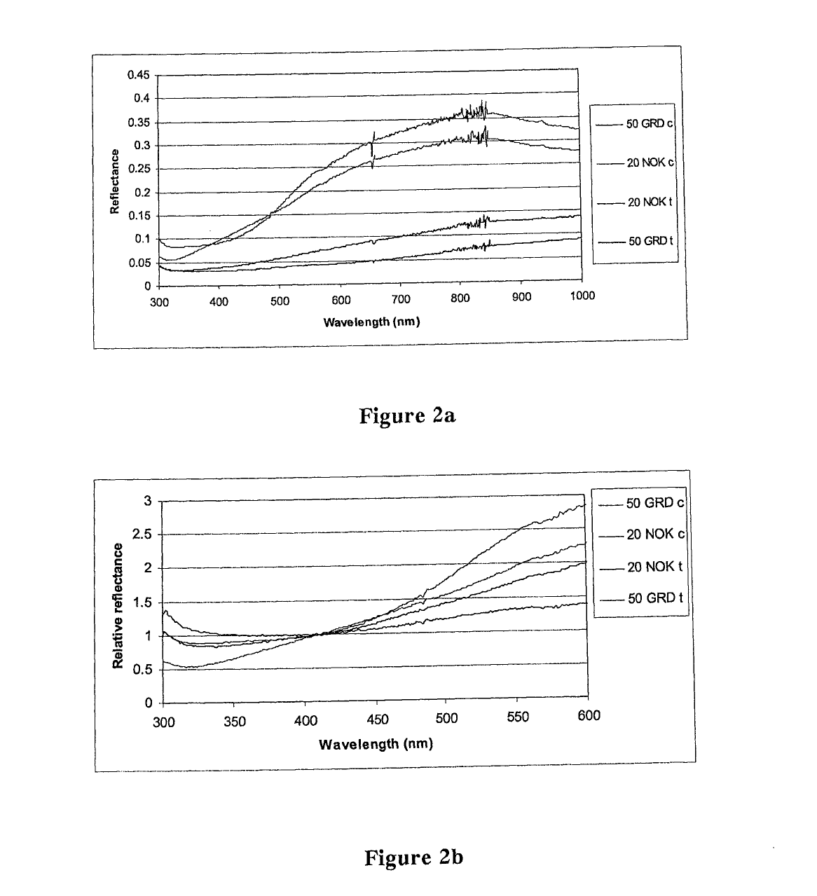

FIG. 2a is a graph showing the relationship between the reflectance of four coins against the wavelength of light applied to the coins;

FIG. 2b is a graph showing the relationship between the relative reflectance of four coins against the wavelength of light applied to the coins the relative reflectance being the original reflectance but scaled so that each coin has the same reflectance at 410 nm (Indigo); and

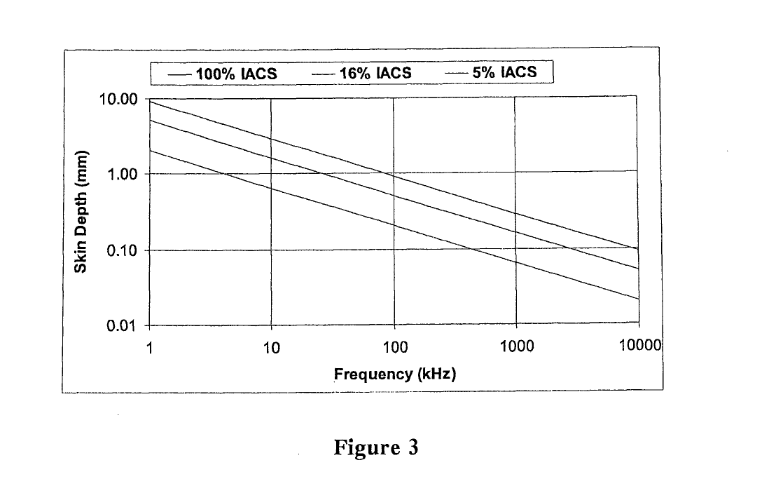

FIG. 3 is a graph showing how different frequencies of applied current penetrate different depths for materials of different conductivity.

The following coin discriminators in accordance with the invention may be used in any coin handling machines, such as coin counting machines, coin sorting machines, vending machines, gaming machines, etc.

The coin discriminators may comprise modular units for use as aftermarket modifications to existing machines or to sensor units of existing machines, or could comprise an integral part of new machines.

Such machines can take any form as is well known in the art. Such machines however, typically comprise at least a coin inlet for receiving coins under test, a coin handler for moving the coins from the coin inlet to a coin discriminator, and a coin sorter, for accepting or rejecting coins according to the output of the coin discriminator.

More particularly the output from the coin discriminator is typically processed by an electronic processor to determine if the coin is genuine or bogus. The processor may comprise hardware or software mounted on or remote from the coin handling machine and may for example comprise a PC although any suitable processor may be used. The electronic processor typically includes a database of stored reference data indicative of properties of the coin that indicate that a coin is genuine, bogus or both. The processor then controls the coin sorter to reject or accept the coin. Rejected coins are typically deflected or moved to a coin reject chute or tray. Accepted coins are typically deflected or moved to a coin storage unit. The coin storage unit may comprise a LIFO type coin storage stack/stacks, or a removable coin bag or box for example.

The coin discriminator may comprise an integral part of a coin sensor unit operative to take multiple measurements of different properties of the coin to form an output, based on the various measurements made, indicative of whether the coin is genuine or bogus. The coin discriminator may comprise a stand alone coin discriminator separate from other sensor unit(s).

The coin handler can comprise any type as is well known in the art. The coin handler may therefore take the form of a rotating wheel operative to sort the coins from the coin inlet into single file before depositing the coins onto a coin conveyor. The conveyor may comprise a planar conveyor belt that carries the coins past the coin discriminator, or may comprise two parallel belts between which the coins are gripped. The wheel may be vertical or inclined.

In another example, the coin handler may comprise a hopper, the base of which comprises a generally horizontally rotating disc. Coins are input to the hopper and are sorted by the rotating disc into single file. The disc may be provided with a resilient peripheral band that grips the sorted coins against the upper surface of the disc so that part of the coin projects radially outwardly from the disc. The coins are carried by the disc as it rotates past the coin discriminator(s). The disc may be inclined if required.

The coin handler could alternatively comprise a chute down which the coins roll in use to the coin sorter. The chute may be oriented such that coins drop down the chute in freefall.

The coin sorter may comprise any type as is well known in the art. Such sorters could comprise solenoid type push rods that may be activated to push a coin to a desired coin outlet, or may comprise a movable finger that deflect the coin to a desired coin outlet.

Electromagnetic Fluorescence/Reflectance

In one aspect of the invention, a coin discriminator is provided for detecting the metal content of a coin. The discriminator comprises a coin inlet for receiving coins under test, at least one electromagnetic emitter adjacent to a coin path from the coin inlet through the discriminator, and at least one electromagnetic fluorescence detector.

In this example the emitter is an x-ray emitter and the detector is an x-ray detector.

When a coin is passed or moved along the coin path, the x-ray emitter emits a plurality of incident x-rays onto part of the coin. Some of the emitted x-rays will be absorbed by the coin but some of the emitted x-rays are sufficient that the coin emits fluorescent x-rays onto the x-ray detector(s) which generates an output signal in dependence upon the energy of the fluorescent x-rays. The output signal is processed by an electronic processor which compares it to stored reference data to determine the material of the coin that is subject to the incident x-rays. The reference data may comprise an acceptable spectrum of fluorescence for a genuine coin.

Example x-ray emitters include a miniaturized x-ray tube, or a small, sealed capsule of radioactive material.

Example x-ray detectors include a crystal such as sodium iodide or a semiconductor devices such as the XR-100CR made by Amptek.

The discriminator is operative to generate fluorescent x-rays from the coin by emitting x-rays of sufficient energy to strike atoms in the coin, dislodging electrons from one of the atoms' inner orbital shells. Each atom regains stability, filling the vacancy left in the inner orbital shell with an electron from one of the atom's higher energy orbital shells. The electrons drops to the lower energy state by releasing fluorescent x-rays, and the energy of these x-rays is equal to the specific difference in energy between two quantum states of the electrons.

When a coin is measured using the above discriminator, each element present in the coin emits its own unique fluorescent x-ray energy spectrum. By measuring the fluorescent x-rays emitted by the different elements in the sample, the electronic processor determines those elements present in the sample and their relative concentrations.

This can be used to check that coins are made from the expected alloy.

It is also envisaged that electromagnetic radiation of other wavelengths/frequencies could alternatively be used.

The radiation may cause fluorescence or reflected radiation from the coin.

Electromagnetic Radiation Absorption

A modification of the above described discriminator comprises an x-ray emitter operative to emit a plurality of incident x-rays of different wave length which strike the coin.

Some of the incident x-rays are absorbed by the coin, whilst some of the incident x-rays pass through the coin and are detected by the x-ray detector which generates an output signal in dependence upon the magnitude of the x-rays detected. The output signal is representative of the absorption characteristic of the material of the coin onto which the incident x-rays were subject.

With reference to the graph of FIG. 1 each trace has a plurality of steps or edges. The steps, or edges, in the graphs occur when the energy of the x-ray photon matches the difference in energy levels between electron orbits within the atom of the material of the coin.

The change in the absorption characteristic as the incident x-ray wavelength changes is compared by an electronic processor to a set of reference values to determine the material of the coin in question.

The intensity of x-rays that have passed through a coin is given by the equation:

I=I₀e^{-μρ d}

Where:

I=intensity of the x-rays through the coin

I₀=the no-coin intensity

μ₀=absorption coefficient from the graph

ρ=the material density

d=the thickness of the coin

The absorption coefficient depends on the elements making up the coin and the wavelength of the x-rays used. In the graph of FIG. 1, the wavelength of the incident x-rays is given in units of electron Volts (eV).

X-ray absorption is used to identify the elements within the alloy of the coin by varying the wavelength of the x-rays emitted from the x-ray emitter so as to identify the absorption step/edge characteristic of each element of the alloy.

Again electromagnetic radiation of the wavelengths/frequencies could alternatively be used.

Colour in Visible and Non-Visible Wavelengths

It is sometimes required to tell coins apart by colour where their size, magnetic properties and electrical conductivity are very similar. In such coins there can however be a slight difference in the colour of the coins. Detecting this difference has been difficult because there is a much greater difference between a shiny new coin and an old tarnished one. The graph of FIG. 2a shows the reflectance of these coins against wavelength. The lowercase letter ‘c’ and ‘t’ after the coin names stand for ‘clean’ and ‘tarnished’.

The graph of FIG. 2 shows the same data scaled such that all four coins have the same reflectance at an example wavelength of 410 nm (indigo).

In this example, at a wavelength of 330 nm there is now a discernible difference between the coins whether they are tarnished or not. It will be appreciated that indigo and near ultra-violet wavelengths have been chosen as an example for these particular problem coins. For other coins any other desired wavelengths can be used as appropriate. Any number of wavelengths can be used as required. Visible, infrared or ultraviolet light can be used as required.

Therefore, in accordance with a coin discriminator of one aspect of the invention at least one light emitter is provided adjacent to a coin path through the discriminator from a coin inlet, and a light detector is provided at a position to detect light reflected from the coin being tested. The light emitter emits incident light-rays of varying wavelengths which strike the coin and reflect onto the detector which generates output signals in dependence upon the magnitude of the light-rays detected.

The output signal is representative of the reflectance characteristic of the material of the coin onto which the incident light-rays were subject for the range of wavelengths of light emitted by the light emitter.

The electronic processor processes the output signals by scaling the measured reflectance of the coin against pre-determined wavelengths to create processed signals indicative of the relative reflectance of the coin. This relative reflectance is compared against a stored set of reference values of relative reflectance of a genuine coin to determine if the coin under test is genuine.

Sound of a Coin Ringing

A prior coin thickness sensor of the applicant uses 40 kHz ultrasonic transducers to measure a coin's thickness. It does this by looking at the phase change of the echo from the coin. It was noted that such a sensor when used with certain coins which tended to hit part of the metal outlet chute of the machine causing enough 40 kHz sound to register on the thickness sensor.

In accordance with another aspect of the invention a coin discriminator comprises a coin inlet for receiving a coin under test and a coin impact surface onto which the coin impacts after having entered the coin inlet. A vibration sensor, such as an ultrasonic microphone, is provided adjacent to the coin impact surface and is operative to generate an output signal in dependence upon the magnitude of the frequency components of the vibration (eg sound vibration) generated in use from the coin impacting the impact surface.

The frequency components of the sound are processed by the electronic processor to provide coin characteristic information which is compared in use to a stored set of reference values for a genuine coin to determine whether or not the coin is genuine.

An example frequency response of the ultrasonic microphone would be up to 100 kHz.

Any other suitable vibration sensor could be used such as a piezoelectric sensor operative to generate an electrical output proportional to the force applied to the sensor by the coin.

Eddy Current Harmonics

Bi-metallic coins like the UK two pound coin are made of an inner disk and outer ring of different materials. The boundary between these two components has a low, but non-zero resistance because the metals are covered in a very thin oxide layer.

We have discovered that when a relatively large current flows across the boundary, this oxide layer can break down causing the resistance to drop.

We have discovered that this effect can be used to distinguish between a genuine coin made of two parts and a single material fake coin that has been plated in the middle to give the appearance of being a bimetallic.

A coin discriminator comprises an induction coil positioned adjacent to a coin path through the discriminator from a coin inlet. The coil is operative to generate a current at a first frequency to the coin under test to induce an eddy current across the bond between the inner and outer parts of a bi-metallic coin under test.

The eddy current generated is measured by monitoring means which generates an output signal indicative of the frequency of the eddy current which is processed by an electronic processor. The processor determines whether the frequency of the eddy current comprises a harmonic frequency of the current initially generated by the coil, the presence of a harmonic current, for example the third harmonic current, being indicative of a change in resistance across the bond between the two parts of the coin. This change in resistance is indicative of the presence of the boundary and thus can enable the electronic processor to generate a signal indicative that the coin is genuine.

As an example, if this type of coil is driven at a frequency of, say 1 MHz, the non-linear bond resistance will generate a small output frequency of 3 MHz. Detecting this 3^{rd} harmonic confirms the existence of the boundary.

It is also envisaged that the oxide layer at the boundary between two parts of a coin could instead comprise a semi-conductor diode arranged to produce a unique eddy current signature. Thus the induction coil of a coin discriminator is arranged to induce an eddy current at a first frequency. The monitoring means generates an output signal indicative of the frequency of the eddy current and again the electronic process determines whether a harmonic frequency, for example, the second harmonic frequency, of the current initially generated by the coil is present and thus whether the coin is genuine.

Multi-Frequency Surface Conductivity

As an anti-counterfeiting measure, a coin may consist of layers of different metals, eg nickel on top of copper on top of iron. To confirm the coin is genuine, it is desirable to check the existence and thickness of the different layers. We have discovered that this can be achieved using the effect of different applied frequencies penetrating different depths into materials of different conductivity, examples of which can be seen in FIG. 3. The conductivity scale is expressed as a percentage of the conductivity of annealed copper. (IACS=International Annealed Copper Standard).

A coin discriminator in accordance with a further aspect of the invention is for discriminating between genuine coins of the type comprising a predetermined number of layers of different metals, and bogus coins.

The discriminator comprises a coil or coils adjacent to the path of a coin under test through the discriminator, the coil or coils being subject in use to a plurality of currents of different frequencies. These induce eddy currents in the layers of the coin.

The discriminator further comprises monitoring means operative to monitor the apparent change of impedance of the coil or coils resulting from eddy currents induced in the various layers of the coin to produce a plurality of output signals representative of changes of the impedance indicative of the thickness of each layer of the coin.

An electronic processor comprises a comparator operative to compare the plurality of output signals against a set of reference values for a genuine coin, to determine whether or not the coin is a genuine coin—ie whether or not the coin has the requisite different layers, and that they are of the correct thickness.

By using at least as many frequencies as the coin has different layers, the electronic processor can generate an estimate for the thickness of each layer.

Core Crinkles/Magnetic Code

It is possible to produce a coin comprising an iron core which is subsequently plated with copper, brass or nickel. In a method in accordance with the invention, before the plating, the iron core is stamped with a simple pattern such as a concentric circle that forms identification means altering a physical characteristic of the coin. The coin core with the pattern is then plated and stamped a second time with a final exterior coin design. This produces a coin where the plating is thicker is some places than in others. This difference in plating thickness is detected using a coin discriminator comprising a small surface conductivity sensor that measures the surface conductivity of a chord across the coin.

It is envisaged that the identification means on the coin could additionally or alternatively comprise plating of different sizes and/or material on the coin. For example a central part of the surface of the coin could be plated differently to the remainder of the coin. Again, a small surface conductivity sensor measures the variation of the conductivity across the different plated regions.

In the above examples, the variation across the coin gives a unique signature.

In an alternative embodiment, the coin identification means could comprise an alteration of the electromagnetic properties of a part of the coin as compared to the remainder of the coin. For example the coin could comprise a circular pattern having different electro-magnetic properties from the remainder of the surface of the coin. In this case a magnetic (permeability) sensor would be used to check for a circular electro-magnetic pattern on the coin. The sensor would ideally be a single sided sensor, similar to a recording head in a tape recorder.

The magnetic marking on the coin can be created in a number of ways. For example, a copper coin plated in nickel can be selectively heated such that the nickel diffuses into the copper in the heated region(s) creating a non-magnetic region or regions.

In order to discriminate a coin of the above type, the nickel layer on a copper coin is used in a similar manner to the magnetic layer on a computer disk. Thus the presence and/or other properties of the nickel layer are tested as the coin passes through a sensor, by attempting to write data to the nickel layer and then attempt to read that data back again using a data reader. This confirms the existence and thickness of the nickel layer and thus be used to determine whether or not the coin is genuine.

Serial Number

A coin can be provided comprising an identifier that can subsequently be detected and used to determine if the coin is genuine.

The identifier could comprise a serial number applied onto or into a coin when it is produced. The serial number could for instance be struck on the coin or “written” on the coin surface using a laser. A plating technique could also be used so that the serial number is plated onto the surface of the coin.

The format of the serial number could be an alphanumeric of letters, numerals or a combination of both, or could be a barcode.

The serial number is read by using an image/colour detector to detect an image which is interpreted by for instance software analysing the image. A laser or barcode scanner comprising part of a coin discriminator could be used to read a barcode.

The serial number, or other suitable coin identification information on the coin is by using a RFID chip that is embedded into the coin.

The RFID chip could be so embedded by initially manufacturing the coin of two halves, such as head and tail in the case of a UK coin. The two coin halves are glued together with the RFID chip between the two coin halves. The two halves are electrically insulated from each other.

An RFID reader can comprise part of a coin discriminator to detect the information on the RFID chip such as the serial number, and any other desired information such as the coin currency and denomination.

1. A coin discriminator for detecting the metal content of a coin, the discriminator comprising a coin inlet for receiving coins under test, at least one electromagnetic radiation emitter adjacent to a coin path from the coin inlet through the discriminator, and at least one electromagnetic radiation detector, the discriminator being operative such that in use, when a coin passes along the coin path, the emitter emits incident radiation onto the coin, the emitted radiation being sufficient that the coin emits radiation, or reflects radiation, onto the detector which generates an output signal in dependence upon the detected radiation, an electronic processor being provided to compare the output signal to stored reference data to determine the material of the coin that corresponds to the radiation detected.

2. The coin discriminator of claim 1 wherein more than one detector is provided.

3. The coin discriminator of claim 2 wherein a detector is provided adjacent to both sides of the coin so as to detect radiation emitted from both sides of the coin.

4. The coin discriminator of claim 1 wherein the emitted electromagnetic radiation are x-rays.

5. The coin discriminator of claim 1 wherein the frequency of the emitted electromagnetic radiation is arranged to generate fluorescence, when incident on a coin.

6. The coin discriminator of claim 1 wherein the frequency of the emitted electromagnetic radiation is arranged to generate reflected radiation, when incident on the coin.

7. A method of detecting the alloy content of a coin using a discriminator comprising a coin inlet for receiving coins under test, at least one electromagnetic radiation emitter adjacent to a coin path from the coin inlet through the discriminator, and at least one electromagnetic radiation detector, the method comprising steps of, when a coin passes along the coin path, controlling the emitter to emit incident electromagnetic radiation onto the coin, the emitted electromagnetic radiation being sufficient that the coin emits radiation, or reflects radiation, onto the detector, generating an output signal from the detector in dependence upon the detected emitted or reflected radiation, using an electronic processor to compare the output signal to stored reference data to determine the material of the coin that corresponds to the emitted or reflected radiation detected.

8. A coin discriminator for discriminating between genuine and reject coins, the discriminator comprising a coin inlet for receiving a coin under test, at least one light emitter adjacent to a coin path from the coin inlet through the discriminator, and at least one light detector, the discriminator being operative such that in use, when a coin passes along the coin path, the light emitter emits light-rays of varying wavelengths onto the coin, the detector detecting said light-rays which reflect off the coin and generating an output signal in dependence upon the magnitude of the reflected light-rays detected, the output signal thus being representative of the reflectance of material of the coin, the discriminator further comprising an electronic processor operative to compare the reflectance of the coin to stored reference data to generate a signal indicative of whether or not the coin is genuine.

9. The coin discriminator of claim 8 wherein the electronic processor processes the output signals by scaling the measured reflectance of the coin against pre-determined wavelengths to create processed signals indicative of the relative reflectance of the coin, this relative reflectance being compared against a stored set of reference values of relative reflectance of a genuine coin to determine if the coin under test is genuine.

10. The coin discriminator of claim 9 wherein the reflectance of the coin is measured against a range of wavelengths so that the processed signals are indicative of the reflectance of the coin as distributed over the range of wavelengths.

11. A method of detecting the metal content of a coin using a coin discriminator comprising a coin inlet for receiving a coin under test, at least one light emitter adjacent to a coin path from the coin inlet through the discriminator, and at least one light detector, the method comprising steps of controlling the light emitter to emit light-rays of varying wavelengths onto the coin, using the detector to detect light-rays which reflect off the coin, generating output signals dependent upon the magnitude and wavelength of the reflected light-rays detected by the detector, the output signal thus being representative of the reflectance of material of the coin, comparing the reflectance of the coin to stored reference data using an electronic processor to generate a signal indicative of whether or not the coin is genuine.

12. A coin discriminator for detecting the metal content of a coin, the discriminator comprising a coin inlet for receiving coins under test, at least one electromagnetic radiation emitter adjacent to a coin path from the coin inlet through the discriminator, and at least one electromagnetic radiation detector, the discriminator being operative such that in use, when a coin passes along the coin path, the emitter is operative to emit incident electromagnetic radiation of multiple wavelengths onto the coin, some of the electromagnetic radiation being absorbed by the coin, whilst some of the incident electromagnetic radiation pass through the coin and are detected by the detector which generates an output signal in dependence upon the electromagnetic radiation detected, the output signal being representative of at least one absorption characteristic of the material of the coin, the discriminator further comprising an electronic processor operative to compare change(s) in the at least one absorption characteristic of the coin as the wavelength of the electromagnetic radiation changes to stored reference data to determine the material of the coin that corresponds to the change(s) in the at least one absorption characteristic of the coin.

13. The coin discriminator of claim 12 wherein the electromagnetic radiation is X-ray radiation.

14. A method of detecting the metal content of a coin using a discriminator comprising a coin inlet for receiving coins under test, at least one electromagnetic radiation emitter adjacent to a coin path from the coin inlet through the discriminator, and at least one electromagnetic radiation detector, the method comprising steps of controlling the emitter when a coin passes along the coin path to emit incident electromagnetic radiation of multiple wavelengths onto the coin, some of the electromagnetic radiation being absorbed by the coin, detecting the incident electromagnetic radiation that pass through the coin using the detector, generating an output signal in dependence upon the electromagnetic radiation detected, the output signal being representative of at least one absorption characteristic of the material of the coin, using an electronic processor to compare change(s) in the at least one absorption characteristic as the wavelength of the electromagnetic radiation changes to stored reference data to determine the material of the coin that corresponds to the change(s) in the at least one absorption characteristic of the coin.
